(19) United States
(12) Patent Application Publication
(10) Pub. No.: US 2003/0120740 A1
(43) Pub. Date: Jun. 26, 2003

(54) System and method for keeping data current

(76) Inventors: Edward S. Beeman, Windsor, CO (US); David W. Boyd, Greeley, CO (US); Michelle R. Lehmeier, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/026,979

(22) Filed: Dec. 20, 2001

(51) Int. Cl. G06F 15/16

(52) U.S. Cl. 709/213; 709/217; 709/246

(57) ABSTRACT

Systems and methods for storing image files over time are disclosed. A method for managing digital data storage over time in a computer based data storage system includes, acquiring an image from a client, associating a representation of the image with the client, storing the representation in a first image file format, receiving a client request for delivery of the image in a preferred image file format, determining if the first image file format is compatible with the preferred image file format, translating the representation from the first image file format to the preferred file format when the first image file format is incompatible with the preferred file format, and delivering the image as desired. The method may be implemented by a data storage system having a primary data storage device, a computing device including an operable data manager, a network interface, and a secondary data storage device. The data manager may be programmed to store and process requests to receive a copy of a stored image in a preferred file format different from the file format used to acquire and/or store the saved image. Preferably, each subsequent file format results in the storage of an additional version of the original image.

### TECHNICAL FIELD

The present disclosure relates to electronic data storage. More particularly, systems and methods for long term electronic data storage management are disclosed.

### BACKGROUND

Traditionally, paper copies of documents have been collected, sometimes indexed and bound, and stored for later retrieval. Document archives can require vast amounts of space and in the case of off-site archives, added shipping, storage, and retrieval costs for those that are required to maintain the underlying data.

Similarly, photographs, prints, and other hard-copy images may be copied and stored for later viewing. These and other hard-copy media are quite durable but can take up a great deal of space as well, particularly when stored they are stored in albums and other protective covers.

Recently, the cost of storing a photograph or other image on digital media has become less than the cost of printing and storing the image(s) on the original or other hard-copy media. This development is a result of the rapid development in both computer system and storage system technologies. While it is desirable to store electronic versions of documents, photographs, and other hard-copy originals in digital formats, the rapid development of computing hardware, storage media, data handling protocols, and data compression techniques create an undesirable situation where the electronic data is no longer as durable as the traditional source.

Magnetic data storage has historically been the data storage mode of choice. Magnetic media permit the storage of large amounts of data. However, ever increasing data storage demands have been met with multiple media transitions over time.

For example, early users of the IBM personal computer had the option of storing data and program files on 5.25″ floppy disks. Conversely, most of today's desktop and laptop computers are configured with 3.5″ floppy disk drives, and/or higher-capacity ZIP® or magnetic tape drives. Consequently, early users who originally stored data on 5.25″ floppy disks were forced to transfer data to one or more different storage media as the 5.25″ disk drives became virtually obsolete.

Similar media transitions are presently underway in the area of digital photography. Some of the first digital cameras were equipped with an integrated 3.541 floppy disk drive for transferring the digital images to a personal computer equipped with a 3.5″ floppy disk drive. Today, only a few of the new digital cameras available are equipped with the 3.5″ floppy disk for data transfer. Most of the digital cameras currently available in the market are equipped with a port that accepts compactflash memory cards of various storage sizes. In addition to the compactflash memory cards common with digital cameras, many video cameras provide universal serial bus (USB) or IEEE 1394 high-performance serial bus (FIREWWRE) ports to permit data transfers to similarly equipped personal computers.

Optical storage media that use holographic data retrieval techniques have greatly increased the amount of data, which can be stored on a removable and relatively small media. Presently, the majority of holographic data storage systems are write once read many or WORM drives. Such systems include CD-ROM and DVD-ROM disk drives. The most common application of this technology is in audio or video compact disks.

The audio CD was introduced jointly by Philips and Sony in 1982. Audio CDs store digital bits as pits (or the absence of pits) impressed in its reflective surface along concentric tracks. The audio CD stores 640-680 MB of information, or about 74 minutes of music, assuming standard sampling rate, frequency, and encoding.

Two competing proposals for high-density optical disks have been announced: the Sony/Philips MultiMedia CD (MMCD) and the Toshiba/Time Warner Super-Density (SD) disk. As currently proposed, the MMCD is a two-layer disk that can hold 3.7 GB on a single layer, for a total capacity of 7.4 GB. The proposed SD disk stores 5 GB on each side, for a total storage capacity of 10 GB.

Various other storage systems are proposed. Three-dimensional (3-D) optical memories, such as volume holograms and two-photon memories, appear very attractive. Holographic storage offers large digital storage capacity, fast data transfer rates, and short access times. Current storage technologies are limited in that they do not simultaneously provide each of these three features. Consequently, current storage technologies will almost certainly evolve.

In addition to the data accessibility problems introduced by hardware and media evolution, data storage formats and data compression techniques also evolve over time. In 1994, the Center for Innovative Computer Applications at Indiana University reported that there were hundreds of various image file formats available (see http://www.cica.indiana.edu/graphics/image.html). Many of the most common image file formats were promulgated to serve a particular imaging and/or data transfer application.

For example, the graphics interchange format (GIF) is a highly compressed format that was designed to minimize file transfer times for users of voice band modems. The GIF file format is well suited for storing images containing consistent colors and sharp edges, such as line drawings and simple cartoons. The joint photographic experts group (JPEG) format supports full 24-bit per pixel color (vs. 8-bit color for GIF) and presents a trade-off of processing (decoding) time vs. economy of data storage and data transfer time. JPEG is limited in that it uses a lossy data compression technique to minimize file sizes. The JPEG format takes advantage of humanly imperceptible information common in real world scenes by removing the information from the digital representation of the image.

Many other image file formats are in use today. One file format, the tagged image file format (TIFF) was primarily designed for raster data interchange. TIFF was designed by developers of printers, scanners, and monitors and has a rich space of information elements for color calibration, gamut tables, etc. Such information is also useful for remote sensing and multi-spectral applications. TIFF supports multiple color spaces, multiple data compression types, and multiple pixel formats.

Other file formats in use support specific data applications. For example, the Geosynchronous Orbiting Environmental Satellite (GOES) system of weather observation satellites generates imagery information using a file format developed for use by the National Oceanic & Atmospheric Administration. By way of further example, the landsat file format was developed for data transfers by the Earth Observation Satellite (EOSAT) company. As image acquisition technology evolves, imagery uses change, and network bandwidth increases, it can be expected that many of today's more common image file formats will also be superseded.

Because current operators of image storage and acquisition devices are unable to predict future advances in bandwidth availability and data storage technology they may always face the possibility of losing previously stored imagery information.

From the above, it will be appreciated that it is desirable to provide a durable system and method for maintaining the viability of digitally stored information.

### SUMMARY

Briefly described, in architecture, a durable electronic data storage system capable of maintaining compatibility with media, data acquisition, and data transfer formats can be implemented with a general-purpose computing device, a mass data storage device, and a plurality of data acquisition devices. The electronic data storage system (EDSS) maintains a database that identifies and permits access to each image stored in the system. The EDSS may acquire images already stored in a digital format via a network or via physical delivery of files contained within various data storage media. Alternatively, the EDSS can translate hard-copy images into suitable digital representations. As data storage media and/or file formats evolve, the EDSS can be adapted to selectively convert previously stored data such that it is suitable for use with new data processing technologies.

Other embodiments of the EDSS may be construed as providing methods for managing digital data storage over time. A preferred method includes the steps of: acquiring images from a client, associating digital representations of the images with the client, saving the digital representations, determining when it is desirable to modify the data storage media and/or the file format, translating the digital representations accordingly, and responding to client requests to access the digital representations.

Other features and advantages of the system and method for removing sensitive data will become apparent to one skilled in the art upon examination of the following drawings and detailed description. It is intended that all such additional features and advantages included herein are protected by the accompanying claims.

### BRIEF DESCRIPTION OF THE DRAWINGS

The EDSS can be better understood with reference to the following drawings. The components in the drawings are not necessarily to scale, emphasis instead being placed upon clearly illustrating the principles of the invention. Moreover, in the drawings, like reference numerals designate corresponding parts throughout the several views.

FIG. 1 is a schematic diagram illustrating various systems and devices suited to communicate with the electronic data storage system (EDSS).

FIG. 2 is a functional block diagram of a general-purpose computer that may be used by the EDSS of FIG. 1.

FIG. 3 is a functional block diagram illustrating a data manager application that may be operable on the general-purpose computer of FIG. 2.

FIG. 4 is a functional block diagram of a fee origination model that may be implemented by the EDSS of FIG. 1.

FIGS. 5A-5E contain a flow chart illustrating a method for managing digital data storage over time.

### DETAILED DESCRIPTION

Systems and methods for managing digital representations of images over time are disclosed. Preferred embodiments of the electronic data storage system (EDSS) manage long term storage of digital photographs. The EDSS acquires, identifies, and stores digital representations of the underlying images. After storing the data, the EDSS maintains data accessibility and compatibility by maintaining legacy equipment, legacy storage media, and/or transferring storage media and translating data storage formats over time.

The EDSS is illustrated and described in its most basic of implementations. It should be appreciated that the EDSS is not limited to this embodiment. For example, the EDSS is illustrated with a single computing device coupled to a single data storage device. Those skilled in the art will appreciate the advantages of configuring the EDSS in a network configuration of multiple computers coupled to multiple remotely located data storage devices. Such a distributed computing and data storage environment will serve to protect client data from localized hardware failures, media damage, and other catastrophic events.

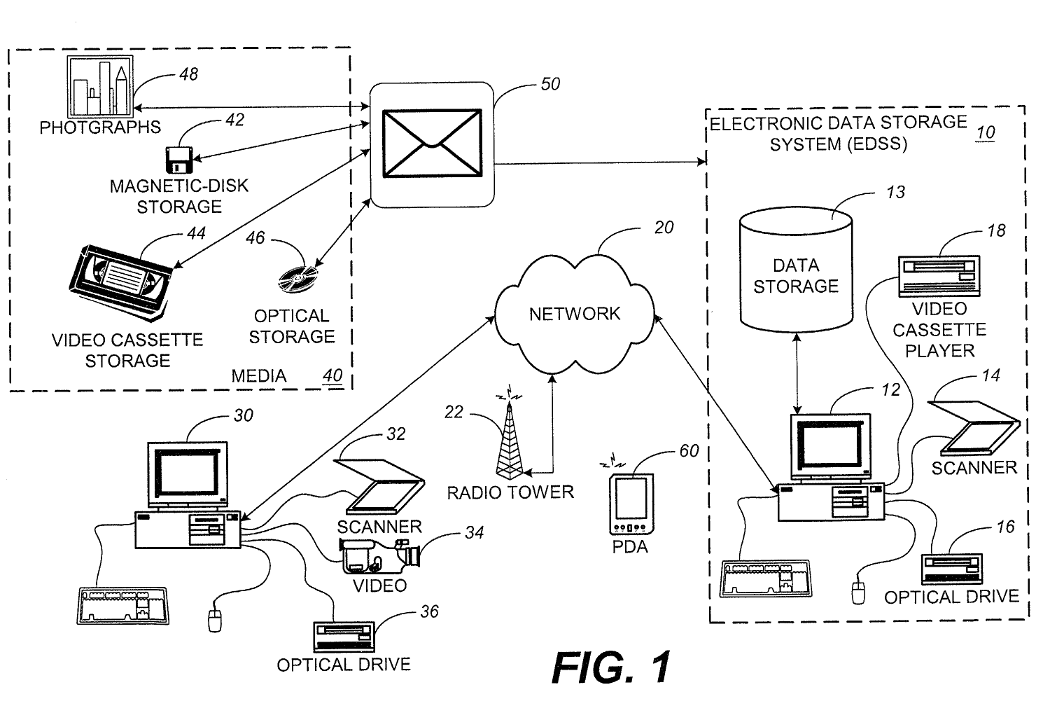

Referring now in more detail to the drawings, in which like numerals indicate corresponding parts throughout the several views, attention is now directed to FIG. 1, which illustrates a schematic diagram of various systems and devices suited to communicate with an electronic data storage system (EDSS). As illustrated in FIG. 1, the EDSS 10 may receive client-acquired images in electronic form via network 20 or in various media formats via one or more courier services 50.

The EDSS 10 may include an image acquisition and data storage management system 12, a data storage device 13, a scanner 14, an optical drive 16, and a video cassette player 18. As illustrated, the image acquisition and data storage management system 12 can be implemented with a general-purpose computing device and may include a number of typical input and output peripherals, such as but not limited to, the keyboard, mouse, and display monitor shown in FIG. 1. Each of the integrated image acquisition and data transfer peripheral devices (e.g., the scanner 14, optical drive 16, and video cassette player 18) may be communicatively coupled to the image acquisition and data storage management system 12 via a port, such as but not limited to a printer port, a USB port, or an IEEE 1394 high-performance serial port.

The scanner 14 enables the EDSS 10 to acquire data representations (i.e., images) of photographs, prints, documents, or other hard-copy originals that may be sent to operators of the EDSS 10 via courier services 50. Courier services 50 may include a postal service, either of a number of commercial delivery services, and/or local couriers. In an alternative embodiment (not shown), clients of the EDSS 10 may personally deliver their hard-copy or storage media to operators of the EDSS 10. After acquiring the data, operators of the EDSS 10 may store the originals or may return the originals in accordance with instruction from the client(s).

Similarly, the optical drive 16 permits the EDSS 10 to acquire digital representations of images previously stored on CD-ROM or DVD-ROM disks. Video cassette player 18 offers another option for acquiring (i.e., transferring) data representations of images stored on videocassette tape.

Once image data has been successfully associated with a particular client and transferred to data storage 13, the stored images will be available for subsequent delivery upon client or client-approved request. For example, client X forwards a number of digital photographs via a CD-ROM to operators of the EDSS 10. Years later, client X's personal computer 30 is destroyed in a fire. Data from that portion of the hard disk drive where the client's personal computer 30 saved the digital representations of the photographs is unrecoverable. The fire also destroyed the client's CD-ROM disk archive. Under these circumstances, the client can retain access to the photographs by submitting a delivery request to operators of the EDSS 10.

A client of the EDSS 10 may, under some circumstances, identify one or more third parties that the client wishes to receive copies of the client's data. In this way, a client with a host of digital images from a family gathering, school reunion, or other social event may rely on the EDSS 10 to release copies of the digital images upon receipt of order requests from multiple third parties interested in viewing the images. By granting third party access to the stored images, client computing resources and network bandwidth may be spared to perform other tasks.

The client may request data delivery via the same media type used to originally deliver the data. Alternatively, the client may request delivery via a more advanced media type that has been added to the EDSS 10. In either situation, operators of the EDSS 10 simply have to transfer the identified files from data storage 13 to the client's media of choice and initiate delivery via courier service 50.

Moreover, the client may ask for delivery via a wide area network such as the Internet. In this situation, operators of the EDSS 10 need only coordinate retrieval of the files from data storage 13 and transmittal via the image acquisition and data storage management system 12. The transmittal may take the form of one or more Email messages with attachments, or alternatively, the data storage management system 12 may be configured to generate a password protected download file for the client and/or any third party granted access to the image(s) of interest. Once the images were accessed and the download file is available to the client, the client could be notified by an Email message.

It should be appreciated that the integrated image acquisition and data transfer peripheral devices (e.g., the scanner 14, optical drive 16, and video cassette player 18) illustrated in FIG. 1 offer data acquisition and translation options for representative popular media types (e.g., the magnetic disk storage 42, video cassette storage 44, optical storage 46, and photographs 48). As technology evolves and one or more of the media types and/or data acquisition and translation devices become obsolete, the EDSS 10 may be upgraded with additional peripheral devices.

Importantly, the scanner 14, optical drive 16, and video cassette player 18 will remain accessible to the image acquisition and data storage management system 12 as long as it is desired to support data storage on an associated media type. Stated another way, as long as operators of the EDSS 10 are responsible for safeguarding images stored on CD-ROM disks, at least one optical drive 16 suited for accessing the previously stored information should remain in the EDSS 10.

FIG. 1 also illustrates that a client may elect to transfer digital representations of images via network 20. In this regard, two exemplary options are illustrated. A first option is exemplified by personal computer 30. As illustrated personal computer 30 may be communicatively coupled to a number of data acquisition and transfer devices. The data acquisition and transfer devices may include a scanner 32, a video camera 34, and an optical drive 36. As further illustrated personal computer 30 may be in communication with the network 20. Consequently, a client operator of the personal computer 30 and/or one or more of the peripheral data acquisition and transfer devices (e.g., the scanner 32, video camera 34, and optical drive 36), may submit one or more images for long term storage to operators of the EDSS 10.

A second data transfer option is exemplified in a wireless data transfer that may originate in a wireless communication device such as, but not limited to, the personal digital assistant (PDA) 60. The PDA 60 may initiate a communication session that may be relayed via one or more radio towers 22 to the network 20. The network 20 may complete the communication link between the PDA 60 and the image acquisition and data storage management system 12 of the EDSS 10.

Periodically, operators of the EDSS 10 may decide that a particular media type should no longer be supported as an option for delivery or transfer of stored image files. Once a new media standard is identified, operators of the EDSS 10 may schedule and perform the necessary media type transition for clients that indicate either a desire to receive copies of the image files on the new media and/or a desire for the EDSS 10 to store a secondary media backup version of the image files.

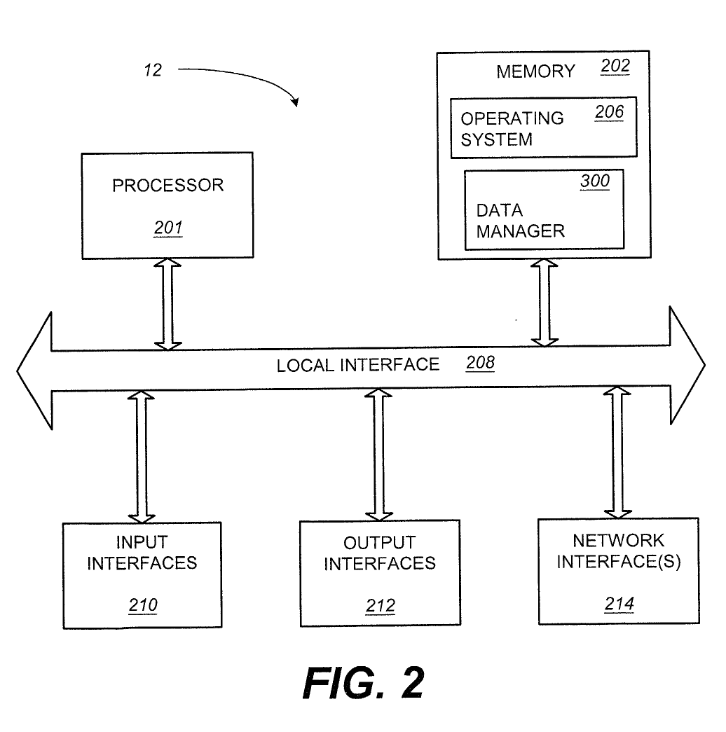

The various systems and devices suited to communicate with the EDSS 10 having been described with regard to FIG. 1, reference is now directed to FIG. 2, which presents a functional block diagram of a general-purpose computer that may be used to implement the image acquisition and data storage management system 12 of the EDSS 10 of FIG. 1. The image acquisition and data storage management system 12, as shown in FIG. 2 may be configured to include a data manager 300.

The data manager 300 is a multi-purpose device configured to control the receipt of data in multiple formats (i.e., both digital and hard-copy), associate a client or owner of the data with the data, store the data in one or more data storage devices, maintain data currency in at least one data storage format, translate and or transform the stored data into a preferred (i.e., presently desired) data format, and distribute data when requested by the client. The data manager 300 may be configured to monitor and control the quality of the data stored as well as generate one or more data storage backups. The data manager 300 may also be configured to control access to data stored within the system as directed by the client owner associated with each particular item stored by the data storage management system 12. In preferred embodiments, the data manager 300 is configured to provide a plurality of options for data delivery (e.g., into the system) storage, and distribution (e.g., back to the owner/client).

In some embodiments, the data manager 300 may be configured to appropriately respond to various client requests for up to date data storage formats of previously stored data items. In addition, the data manager 300 may be configured to retain and/or update the data storage medium and/or data storage format used to store the various data under its control.

Generally, the image acquisition and data storage management system 12 can be a general-purpose computer. The image acquisition and data storage management system 12 may include a processor 201, memory 202, input devices 310, output interfaces 212, and a network interface 214 that communicate with each other via a local interface 208. The local interface 208 can be, but is not limited to, one or more buses or other wired or wireless connections as is known in the art. The local interface 208 may have additional elements, such as buffers (caches), drivers, and controllers (omitted here for simplicity), to enable communications. Further, the local interface 208 includes address, control, and data connections to enable appropriate communications among the aforementioned components. The processor 201 is a hardware device for executing software, such as the data manager 300, stored in memory 202. The processor 201 can be any custom made or commercially available processor, a central processing unit (CPU) or an auxiliary processor among several processors, a microprocessor and/or a macro-processor.

The memory 202 can include any one or a combination of volatile memory elements, such as random access memory (RAM, DRAM, SDRAM, etc.), and non-volatile memory elements, such as read only memory (ROM), hard drive, tape, CD-ROM, etc. Moreover, the memory 202 may incorporate electronic, magnetic, optical, and/or other types of storage media.

The input devices 310 may include, but are not limited to ports configured to communicate with a microphone, keyboard, mouse, other interactive pointing devices, and/or other suitable operator-machine interface devices. The input devices 310 may also include ports suited to communicate with image acquisition devices such as the scanner 14, video camera 34, and other similar devices (FIG. 1). Each of the various input devices 310 may be in communication with the processor 201 and/or the memory 202 via the local interface 208. Data received from an image acquisition device connected as an input device or via the network interface 214 may take the form of a file or files that can be stored in memory 202 as image files.

The output interfaces 212 may include a display interface that supplies a display video output signal to a monitor associated with the image acquisition and data storage management system 12. Display monitors associated with the display interface can be conventional cathode ray tube (CRT) based displays, liquid crystal displays (LCDs), plasma displays, or other display types. The output interfaces 212 may also include other well-known devices such as plotters, printers, and various film developers. It will be appreciated that a video signal may also be supplied to a number of storage devices, such as but not limited to, a videocassette recorder (VCR), a compact disc recorder, or similar devices to record a plurality of images.

The local interface 208 may also be in communication with input/output devices that connect the image acquisition and data storage management system 12 to one or more networks such as the network 20 (FIG. 1). These two-way communication devices include, but are not limited to, modulators/demodulators (modems), network cards, radio frequency (RF) or other transceivers, telephonic interfaces, bridges, and routers. For simplicity of illustration, such two-way communication devices are not shown. Preferably, a plurality of image acquisition and data storage management systems 12 (one shown in FIG. 1) will be integrated in the EDSS 10. Each of the image acquisition and data storage management systems 12 may be configured with network interfaces 214 that support both local area network (LAN) as well as wide area network (WAN) connectivity. In preferred embodiments, WAN connectivity includes access to the public network commonly known as the Internet.

Information stored in memory 202 may include one or more separate programs comprised of executable instructions for implementing logical functions. In the example of FIG. 2, software in memory 202 includes the data manager 300 and a suitable operating system 206. A non-exhaustive list of commercially available operating systems includes Windows from Microsoft Corporation, Netware from Novell, and UNIX, which is available from many vendors. The operating system 206 controls the execution of other computer programs, such as the data manager 300, and provides scheduling, input/output control, file management, memory management, communication control, and other related services.

The processor 201 and operating system 206 define a computer platform, for which application programs, such as the data manager 300, may be written in higher level programming languages. It will be appreciated that each of a plurality of image acquisition and data storage management systems 12 may be configured to run a host of applications simultaneously using the aforementioned computer platform. It will be further appreciated that the software and/or firmware in memory 202 may also include a basic input output system (BIOS) (not shown). The BIOS is a set of essential software routines that test hardware at startup, launch the operating system 206, and support the transfer of data among hardware devices. The BIOS is stored in read-only memory and is executed when the computer and/or image acquisition device is activated.

When the image acquisition and data storage management system 12 is in operation, the processor 201 executes software stored in memory 202, communicates data to and from memory 202, and generally controls operations of the underlying device pursuant to the software. The data manager 300, the operating system 206, and other applications are read in whole or in part by the processor 201, buffered by the processor 201, and executed.

The data manager 300 can be implemented in software, firmware, hardware, or a combination thereof. In the preferred embodiment, the data manager 300 is implemented in software as an executable program and is performed by a general-purpose purpose computer, such as a personal computer, workstation, minicomputer, or mainframe computer. Alternatively, the data manager 300 may be a source program, script, or any other entity containing a set of instructions to be performed. Furthermore, the data manager 300 can be written in an object oriented programming language, which has classes of data and methods, or in a procedure programming language, which has routines, subroutines, and/or functions. Examples of these languages include but are not limited to C, C++, Pascal, Basic, Fortran, Cobol, Perl, Java, and Ada.

When the data manager 300 is implemented in software, as shown in FIG. 2, it should be noted that the data manager 300 can be stored on any computer readable medium for use by or in connection with any computer related system or method. In the context of this document, a computer readable medium is an electronic, magnetic, optical, or other physical device or means that can contain or store a computer program for use by, or in connection with a computer related system or method. The computer readable medium can be, for example but not limited to, an electronic, magnetic, optical, electromagnetic, infrared, or semiconductor system, apparatus, device, or propagation medium.

Data Manager Architecture and Operation

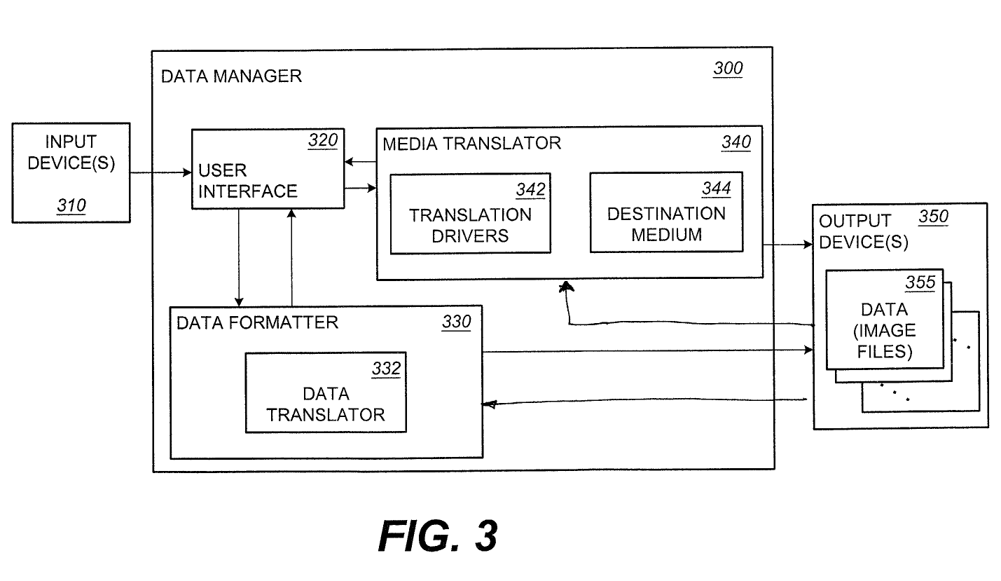

Reference is now directed to FIG. 3, which presents a functional block diagram that further illustrates the data manager 300 that may be operable on the image acquisition and data storage management system 12 of FIGS. 1 and 2. Shown here, the data manager 300 may include a user interface 320, a data formatter 330, and a media translator 340.

The data formatter 330 is in communication with the user interface 320 and may receive source data from one or more input devices 310. The source data may take the form of one or more image files stored under various file formats. The input devices 310 will include computer peripherals configured to acquire and translate images into a digital representation of a hard-copy source in the form of an image data files or files. The input devices 310 will also include computer peripherals configured to store and transfer digital representations of stored images in the form of image data files.

As illustrated in FIG. 3, the data formatter 330 may include a data translator 332 configured to translate data previously acquired and arranged in any of a number of various source file formats to a desired format suited for long term data storage in data storage 13 (FIG. 1) and/or storage on a plurality of suitable storage media. As further shown in FIG. 3, the data formatter 330 is configured to forward the translated data 334 to output devices 350.

Data manager 300 may also include a media translator 340. The media translator 340 may also receive source data from one or more input devices 310. The source data may take the form of one or more image files stored under various file formats. The input devices 310 will include computer peripherals configured to store and translate images on various data storage media in the form of an image data files or files.

As further illustrated in FIG. 3, the media translator 340 may include translation drivers 342 (one shown) configured to transfer data previously arranged on any of a number of various data storage media to a desired new data storage media. As also illustrated in FIG. 3, the media translator 340 is configured to forward the translated data to output devices 350 suitable for storing the translated data files on a data storage medium.

In an alternative embodiment, the data formatter 330 may also contain an image data file indexer (not shown). The indexer may be configured to extract and/or collect client and image data identification information and insert the same into a header or other imbedded portion of an appropriate image file.

In another alternative embodiment, the data manager 300 may contain a plurality of image editors (not shown). The image editors may permit an operator of the data manager 300 to perform a plurality of image editing tasks as an additional service to the client. For example, an original source data file may contain images of family photographs acquired with a camera technology that reflects red light from the retinas of the eyes of subjects in flash enhanced photographs. An exemplar image editor may localize the undesired “red-eye” and overlay a color or colors representative of human eyes. A separate image editor may be configured to apply text or symbols as an overlay over the underlying imagery stored in an image file. The overlayed text and/or symbols may be used to further identify or enhance the underlying image. The identifying information may include labels, acquisition information such as machine settings, data related to the subject, and so forth. An image editor may also allow an operator to selectively apply image masks.

Preferably, the data manager 300 is configured to interface with a plurality of output devices 350, which render or convert the image data files into an operator observable image 355. For example, the data manager 300 may send a data image 355 to a display monitor, which then converts the image into a format suitable for general viewing. Other output devices 350 may store the image data file on an appropriate data storage medium. Some other output devices 350 may be suitable for backup data storage, faxing, printing, electronic mailing, etc. In an alternative embodiment, the image data 355 may be temporarily stored on a data storage device operable with an Internet site configured to permit download access to the file to appropriately identified visitors to the Internet site. It should be appreciated that once the image data 355 is available in buffers associated with other peripherals, it is no longer dependent upon the data manager 300 and can be processed externally. Once an image has been stored on a networked device, outside of the control of the data manager 300, the underlying image data and/or index information may be available to operators with or without appropriate file access.

Those skilled in the art will appreciate that various portions of the data manager 300 can be implemented in hardware, software, firmware, or combinations thereof. In a preferred embodiment, the data manager 300 is implemented using a combination of hardware and software or firmware that is stored in memory and executed by a suitable instruction execution system. If implemented solely in hardware, as in an alternative embodiment, the data manager 300 can be implemented with any or a combination of the following technologies which are well known in the art: discrete logic circuits, application specific integrated circuits (ASICs), programmable gate arrays (PGAs), field programmable gate arrays (FPGAs), etc.

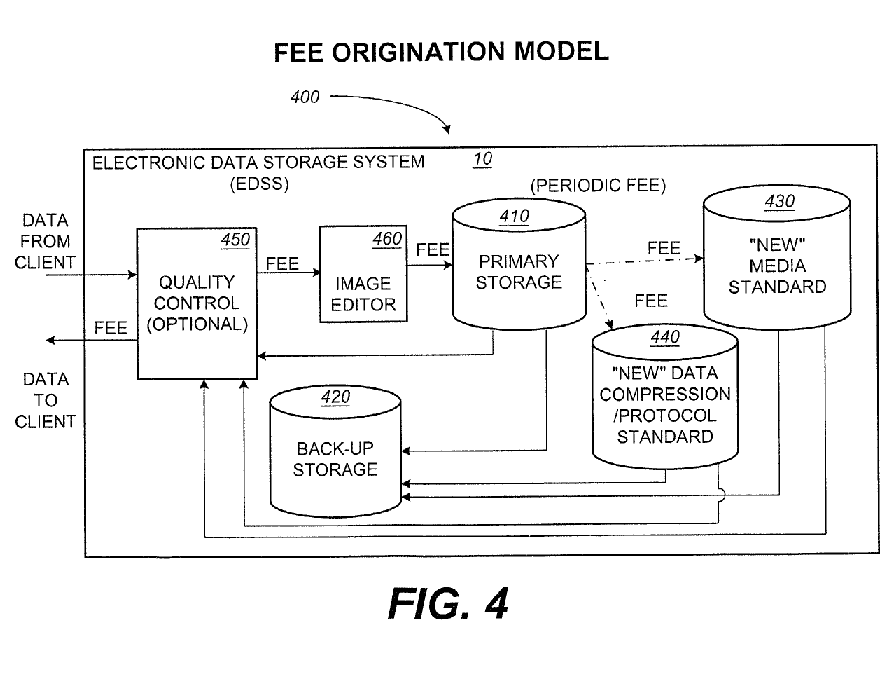

The data manager 300 having been described with regard to the functional block diagram of FIG. 3, reference is now directed to FIG. 4, which illustrates an exemplary fee origination model 400 that may be implemented by the EDSS 10 of FIG. 1. In this regard, the EDSS 10 may receive data from one or more clients in the form of electronic data (i.e., image) files, hard-copy items, and/or electronic data files stored on various data storage media. The received data, regardless of format, will be saved in primary storage 410 with a backup copy placed within backup storage 420. As shown in the fee origination model of FIG. 4, a client fee may be generated upon image data file storage in the primary storage 410. In addition, periodic storage maintenance fees may be generated and forwarded to clients of the EDSS 10 who wish to store files with the service over time.

In preferred embodiments, backup storage 420 is implemented via a network connection to one or more WAN-coupled remote sites containing appropriately configured data storage devices. In alternative embodiments, backup storage 420 may be implemented via a network connection to one or more LAN-coupled computing devices in communication with appropriately configured data storage devices. In yet other embodiments, backup storage 420 may be distributed via one or more combinations of appropriately configured data storage devices either in direct communication with the data storage management system 12 or in communication with the data storage management system 12 via one or both of a LAN and a WAN.

While individual backup storage devices may vary between and across both primary and backup data storage locations, preferred embodiments include a Redundant Array of Inexpensive Disk(s) (RAID) (not shown) configured with appropriate software to appropriately distribute and copy data to assure data accessibility and recoverability with a much higher degree of reliability over simply relying on individual disk drives to store the underlying data files. RAID storage management is well known and need not be described in detail to understand the EDSS 10. Those skilled in the art of data storage can integrate RAID data storage with the EDSS 10 such that the EDSS 10 can successfully store, backup, and retrieve specific client data files as desired.

As further illustrated in FIG. 4, the EDSS 10 may be configured to generate a client fee when previously stored data files are transferred to a new storage media 430 and/or when it is determined that the previously stored data files are to be translated and stored under a new data compression or file format 440. For example, in an alternative embodiment, the EDSS 10 may be configured to translate a previously stored data file when a specific data request is for that file is received. This particular configuration will prevent an operator of the EDSS 10 from performing data translations to formats that may never be requested by the client.

As previously described with regard to FIG. 1, a number of occurrences may initiate a data storage transfer to a new storage media and/or data storage under a new data compression or file format. Regardless of the particular initiating action and the resulting EDSS 10 response, each subsequent data manipulation after the original data storage transaction may result in an updated backup, as well as an optional quality control verification of the client's data. These data manipulation backups and quality control checks may be necessary to ensure the client's data is not degrading over time (e.g., as may be expected upon each subsequent application of a lossy data compression format).

It should be appreciated that the image acquisition and data storage management system 12 may be configured to record individual data transactions and periodically generate fee invoices and/or client account debits in accordance with an agreed upon fee schedule for the various data editing, storage, media translation, and file format translations. For example, the image acquisition and data storage management system 12 may be configured to generate a periodic fee in return for the security that the client can access the data in a desired format. As also illustrated in FIG. 4, the EDSS 10 may be configured to simply retrieve data files from primary storage 410. The retrieved data files may be delivered to the appropriate client or a third party requestor of the files with appropriate access capability as may be controlled by the image acquisition and data storage management system 12. It should be further appreciated that the retrieved data files may be delivered after having been stored on a client selected data storage medium, they may be delivered via an electronic mail message, or as previously described they may be placed in a temporary client accessible download file on an Internet site.

In alternative embodiments, data may be optionally received and reviewed by quality control 450 prior to placement in primary storage 410. In addition, data files may be processed by an image editor 460. Quality control 450 may take the form of electronic verification of the data format and size of an associated file or files or, in the case of hard-copy sources, may include verification of data acquisition and image quality via review by an operator of the EDSS 10. The image editor 460 may perform a plurality of value added services as described hereinabove. Each value-added service may be added by the image acquisition and data management system 12 to the appropriate client account.

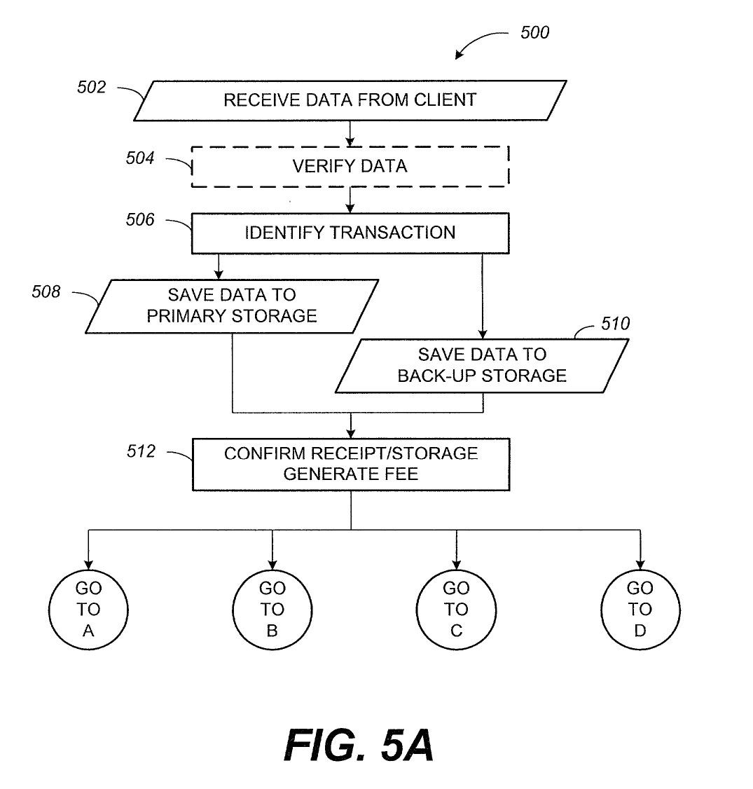

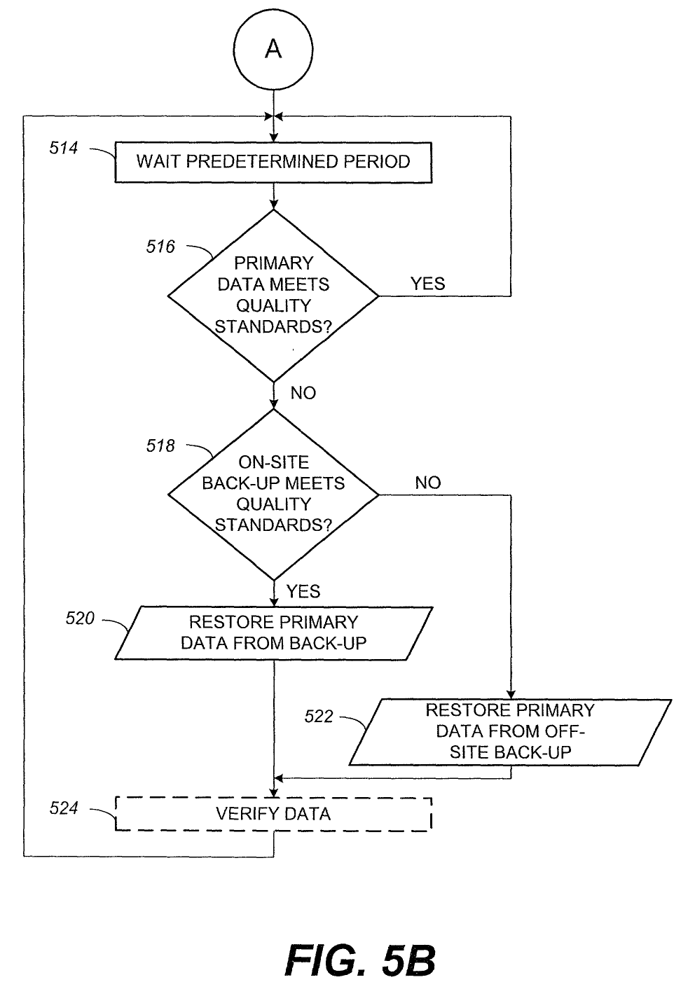

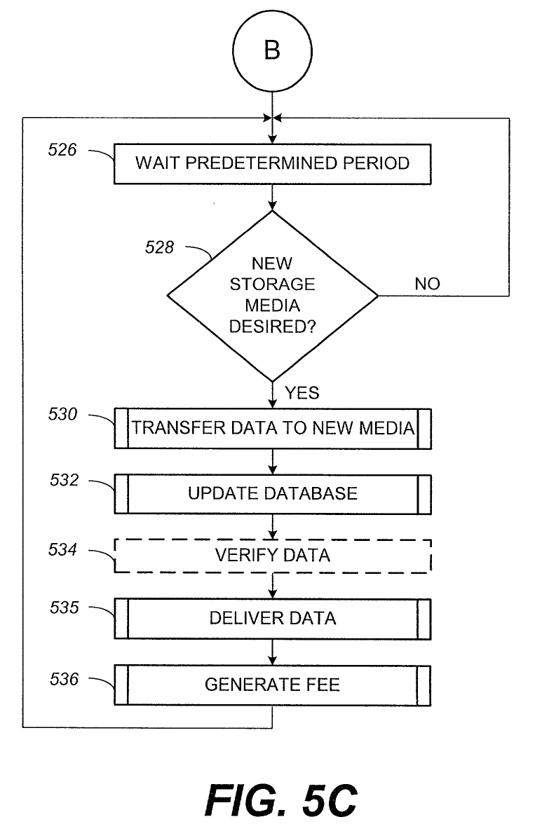

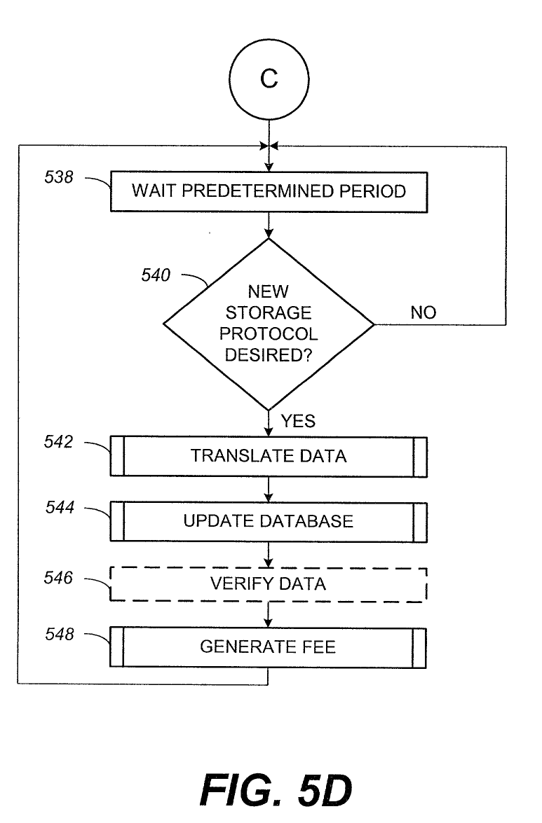

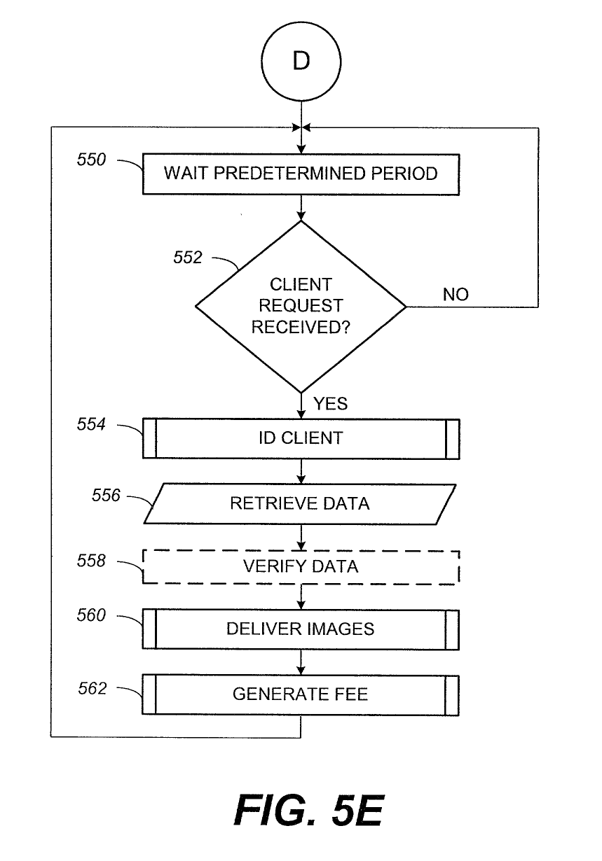

Reference is now directed to FIGS. 5A-5E, which contain a flow chart illustrating a method for managing digital data storage over time. The method for managing digital data storage over time 500 may begin with step 502 where the EDSS 10 (FIG. 1) receives data from a client. As previously described, the client data may take the form of hard copy, such as documents, copies, photographs, print, etc. or alternatively the data may be previously formatted and stored on a data storage medium. Next, in optional step 504, the EDSS 10 may be configured to verify the quality of the received data prior to continuing with an initial data acquisition stage.

When the data is deemed acceptable for continued processing, the EDSS 10 may perform step 506 where a client storage transaction is identified. The identify transaction step 506 may entail populating a database with client identification and contact information, a transaction identification, one or more descriptions of the underlying source(s) submitted by the client, any special processing/acquisition instructions, as well as, information regarding access to third parties. Special processing/acquisition instructions may include client preferences for acquiring digital images from hard-copy source, application of one or more image editors to the acquired images, as well as, instructions regarding the level of redundancy regarding backups and/or periodic delivery of particular images or portions of images to third parties.

For example, a business that is a client of the operators of the EDSS 10 may periodically order stationery and envelopes from several different printing companies. If the business has previously stored a digital data representation of a logo, trademark, service mark, etc. that they want printed on their stationery and envelopes, by way of special instruction, the business could identify printing companies that they wish to share their data. Operators of the EDSS 10 may in turn, confirm the request to grant third party access with their client prior to delivering the data.

As illustrated in steps 508 and 510 after the EDSS 10 has appropriately acquired and identified the data to be stored, the EDSS 10 may place a copy of the source data in primary storage (step 508). One or more additional copies of the source data may be saved at one or more backup storage locations (step 510) in order to provide at least one failure safe backup should the primary storage facility and/or data storage medium become unusable. Operators of the EDSS 10 may present data storage clients multiple backup and storage media options each having a different fee. Clients with extremely important data may request a higher degree of reliability and/or care of their stored images.

It should be appreciated that backup storage may be implemented on different storage media than that used to implement the primary data storage. It should be further appreciated that multiple backups may be stored across multiple locations in order to reduce the probability of stored data becoming unusable due to local disasters, hardware failures, and the like.

After storing the data (steps 508 and 510) the EDSS 10 may be configured to confirm completion of the data storage process and generate a fee as illustrated in step 512. Importantly, the EDSS 10 may be programmed to record the primary data storage location and the one or more secondary or backup data storage locations of the client's data files using a method or methods external to the one or more data storage's file management systems. In this way, operators of the EDSS 10 can ensure access to stored client data, even if the EDSS 10 suffers from multiple hardware failures.

At this point, the method for managing digital data storage over time 500 may perform several multiple step procedures over time. In the flowchart of FIG. 5A, the several multiple step procedures may form branches A, B, C, and D as illustrated. The various procedures illustrated in FIGS. 5B through 5E are presented without regard to the relative importance of the underlying procedure. The procedures may overlap in time and under some circumstances multiple procedures may be performed simultaneously.

Periodic Data Quality Verifications

For example, the process steps illustrated in FIG. 5B illustrate a stored data quality check. After storing client data for a predetermined amount of time as illustrated in step 514, the EDSS 10 may be programmed to initiate a data quality query in step 516 to determine if the stored client data in the primary storage location meets a particular data quality standard. If the data passes the query of step 516, the EDSS 10 may be programmed to simply wait for the predetermined period before verifying the stored data as indicated by the flow control arrow labeled, “yes” Otherwise, when the query of step 516 resulted in a negative response, the EDSS 10 may be programmed to check the contents of the on-site backup of the client's files as indicated in step 518. When the on-site backup data meets quality standards, the EDSS 10 may restore the primary data storage files by copying the backup data as shown in step 520. When the on-site backup also fails to meet quality standards, as illustrated by the flow control arrow labeled, “no” exiting the query of step 520, the EDSS 10 may restore the primary data files from an off-site backup of the client's files as illustrated in step 522. After the EDSS 10 has restored the client's data in both the primary and backup data storage devices, the EDSS 10 may be programmed to verify the client's data as shown in step 524. As indicated by the flow control arrow exiting step 524, the EDSS 10 may be programmed to return to step 514 where steps 514 through 524 may be repeated as may be desired.

Media Transfers

A second procedure is illustrated in FIG. 5C. In this regard, the procedure steps reveal a process for transferring stored client data onto a new data storage media. Procedure steps 526 through 536 may be performed in response to a client request to deliver a copy of one or more files via a particular data storage media. For example, a client may have previously transferred a family photo album stored on a plurality of 3.541 floppy disks for long term storage in the EDSS 10. Later, the client desires to have a copy of the stored image files representing the photographs in the photo album sent a cousin via a single compact disk.

After storing client data for a predetermined amount of time as illustrated in step 526, the EDSS 10 may be programmed to initiate a query in step 528 to determine if it is desired to transfer or copy stored client data to a new storage media. When the response to the query of step 528 is negative, the EDSS 10 may be programmed to return to step 526 as illustrated by the flow control arrow labeled, “no” that exits the query of step 528. Otherwise, if it is desired to generate a copy of one or more stored image files, the EDSS 10 may be programmed to perform step 530, where the identified image files are transferred to the new storage media.

Next, as shown in step 532, the EDSS 10 may be programmed to update the database accordingly. In an optional step, the data quality may be verified on the new storage media as illustrated in step 534. After the requested image files have been transferred to the storage media, the EDSS 10 may deliver the data per the client request and generate a client fee as shown in steps 535 and 536. As indicated by the flow control arrow exiting step 536, the EDSS 10 may be programmed to return to step 526 where steps 526 through 536 may be repeated as desired.

Storage Protocol Translations

A third procedure is illustrated in FIG. 5D. In this regard, the procedure steps reveal a process for translating previously stored client data into a new data storage protocol. Procedure steps 538 through 548 may be performed in response to a decision by operators of the EDSS 10 that data stored under an obsolete data storage format will no longer be supported by the EDSS 10.

For example, users of ultrasound equipment in the field of medical diagnostic imaging may have stored patient images under the American College of Radiology (or .acr) file format. Recently, the American College of Radiology—National Electrical Manufacturers Association (ACR-NEMA) promulgated an updated imaging standard known as the Digital Imaging and Communications in Medicine or DICOM. In a few years, the number of requests for images in the .acr format may diminish dramatically. In order to keep the data accessible and current the operators of the EDSS 10 may translate previously stored client data files from the .acr format to the DICOM format.

It should be appreciated that the data translation may be performed by maintaining equipment compatible with both the .acr and the DICOM standard. In one data translation mode, the image files may be displayed by the .acr equipment and recorded using equipment that operates under the DICOM standard. In the preferred data translation mode, a software-based translation is performed to convert the data.

After storing client data for a predetermined amount of time as illustrated in step 538, the EDSS 10 may be programmed to initiate a query in step 540 to determine if it is desired to translate stored client data to a new data storage protocol. When the response to the query of step 540 is negative, the EDSS 10 may be programmed to return to step 538 as illustrated by the flow control arrow labeled, “no” that exits the query of step 540. Otherwise, if it is desired to translate one or more stored image files, the EDSS 10 may be programmed to perform step 542, where the identified image files are translated to the new storage media. It should be appreciated that both the original data file and the new data file may remain in the EDSS 10.

Next, as shown in step 544, the EDSS 10 may be programmed to update the database accordingly. In an optional step, the data quality may be verified on the new storage media as illustrated in step 546. After the requested image files have been translated as desired, the EDSS 10 may generate a client fee as shown in step 548. As indicated by the flow control arrow exiting step 548, the EDSS 10 may be programmed to return to step 538 where steps 538 through 548 may be repeated as desired.

Client Requests

A fourth procedure is illustrated in FIG. 5E. In this regard, the procedure steps reveal a process for delivering stored client data. Procedure steps 550 through 562 may be performed in response to a client request to deliver a copy of one or more image files. For example, a client may have previously transferred a host of scanned image data files containing important documents such as, but not limited to, birth certificates, vehicle titles, an executed will, etc. to the EDSS 10. Later, the client desires a copy of the vehicle titles.

After storing the client data for a predetermined amount of time as illustrated in step 550, the EDSS 10 may be programmed to initiate a query in step 552 to determine if a client request has been received. When the response to the query of step 552 is negative, the EDSS 10 may be programmed to return to step 550 as illustrated by the flow control arrow labeled, “no” that exits the query of step 552. Otherwise, if it is desired to generate and deliver copies of one or more stored image files, the EDSS 10 may be programmed to perform step 554, where client identification information from the requestor is extracted from the request and applied against the image data storage system to identify matches between the items requested and the previously stored data. Where matches are identified, the requested image files are retrieved from primary storage or backup storage as necessary as illustrated in step 556.

Next, as shown in step 558, the EDSS 10 may be programmed in an optional step to verify the quality of the retrieved data. After the requested image files have been identified, access and data quality has been verified, the EDSS 10 may be programmed to deliver the requested images in accordance with the client's requested delivery mode as shown in step 560. After delivering the data per the client request, the EDSS 10 may generate a client fee as shown in steps 562. As indicated by the flow control arrow exiting step 562, the EDSS 10 may be programmed to return to step 550 where steps 550 through 562 may be repeated as desired.

Process descriptions or blocks in the flow charts of FIGS. 5A-5E may represent modules, segments, or portions of code which include one or more instructions for implementing specific steps in the method for managing digital data storage over time 500. Alternate implementations are included within the scope of the preferred embodiment of the EDSS 10 (FIG. 1) in which functions may be executed out of order from that shown or discussed, including concurrent execution or in reverse order, depending upon the functionality involved, as would be understood by those reasonably skilled in the art of the present invention. For example, as described above, it is contemplated that the various image-editing processes may be integrated within an image acquisition system, as well as within an image enhancer operable on post acquisition processing platforms.

It should be emphasized that the above embodiments of the EDSS 10, particularly any preferred embodiments, are merely possible examples of implementations and are set forth for a clear understanding of the principles of the associated method for managing digital data storage over time 500. Variations and modifications may be made to the above embodiments of the EDSS 10 and the various methods without departing substantially from the spirit and principles thereof. All such modifications and variations are intended to be included within the scope of this disclosure and protected by the following claims.

What is claimed is:

1. A method for managing digital data storage in a computer based data storage system, comprising:
acquiring a representation of an image from a client;
associating the representation of the image with the client;
storing the representation in a first image file format in the data storage system;
receiving a client request for delivery of the stored representation in a preferred image file format;
determining if the first image file format is compatible with the preferred image file format wherein the data storage system translates the representation from the first image file format to the preferred file format when the first image file format is incompatible with the preferred file format; and
delivering the representation of the image in the preferred file format.

2. The method of claim 1, wherein acquiring comprises transforming a hard-copy source into the first image file format.

3. The method of claim 1, wherein acquiring comprises processing at least one file associated with an electronic mail message.

4. The method of claim 1, wherein acquiring comprises a direct network transfer from a client-computing device to the computer based data storage system.

5. The method of claim 1, wherein associating comprises inserting a data storage system file identifier into a transaction record of a database.

6. The method of claim 1, wherein storing comprises saving at least one instance of the representation on a primary data storage medium and saving at least one instance of the representation on a secondary data storage medium.

7. The method of claim 1, further comprising:
maintaining a copy of the representation in the first image file format and in subsequent preferred file formats in the data storage system.

8. The method of claim 1, wherein the data storage system translation is initiated by the obsolescence of the first file format.

9. The method of claim 1, wherein the data storage system translation is initiated by a customer request to access the image.

10. The method of claim 1, wherein delivering comprises transferring the representation in the preferred file format over a network.

11. The method of claim 1, wherein delivering comprises transferring the representation to at least one portable data storage media.

12. The method of claim 1, further comprising:
transferring the representation to a hard-copy medium.

13. The method of claim 1, further comprising:
editing the representation in accordance with a client request; and
generating a fee upon storing the edited representation.

14. The method of claim 1, further comprising:
generating a fee upon translating the representation.

15. The method of claim 1, further comprising:
generating a fee upon delivering the representation.

16. The method of claim 1, further comprising:
generating a periodic fee in return for providing data access.

17. The method of claim 1, further comprising:
controlling third party access to the stored representation in accordance with client direction.

18. The method of claim 6, wherein the secondary data storage medium is geographically disposed from the primary data storage device.

19. A computer based data file storage management system, comprising:
means for acquiring a digital representation of at least one image from a client;
means for identifying the client;
means for storing the digital representation in a first file format;
means for processing requests for copies of the stored digital representation wherein the request contains information indicative of a preferred file format and a preferred delivery medium;
means for translating the digital representation to the preferred file format responsive to the determining means; and
means for transferring the digital representation from the means for storing to the preferred delivery medium.

20. The system of claim 19, further comprising:
means for controlling third party access to the stored digital representation responsive to a client initiated distribution schedule.

21. The system of claim 19, wherein the processing means is responsive to a client request to receive the digital representation in the second file format.

22. The system of claim 19, wherein the acquiring means comprises a computing device in communication with the client via a wide area network.

23. The system of claim 19, wherein the acquiring means comprises a digital imaging device.

24. The system of claim 19, wherein the translating means is a software program operable on a computing device in communication with the file storage management system.

25. The system of claim 20, wherein the controlling means comprises a database.

26. A computer-readable medium having a computer program, comprising:
a logic configured to associate a client with a digital representation of an image in a first image file format;
a logic configured to store the digital representation;
a logic configured to receive client requests for delivery of the digital representation in a delivery file format;
a logic configured to retrieve the digital representation from storage responsive to the received client request;
a logic configured to transform the digital representation when the first image file format is not in conformance with the delivery file format.

27. The computer-readable medium of claim 26, further comprising:
a logic configured to receive third-party requests for delivery of the digital representation in a third party desired file format, wherein the logic configured to retrieve is responsive to a client initiated third party access grant and wherein the logic configured to transform modifies the digital representation when the first image file format is not in conformance with the desired file format.

28. The computer-readable medium of claim 26, further comprising:
a logic configured to transfer the digital representation from the stored representation to a preferred data-delivery medium.

29. An electronic data storage system, comprising:
a primary data storage device;
a computing device communicatively coupled to the primary data storage device, the computing device having an execution memory containing a data manager application;
a network interface operable to communicatively couple the computing device to a client and a secondary data storage device via a wide area network, wherein the data manager is programmed to process a client request to store an image by saving a digital representation of the image in a first file format within both the primary data storage device and the secondary storage device and wherein the data manager is further programmed to process a request to receive a copy of the image in a preferred file format.

30. The system of claim 29, further comprising:
an image acquisition device in communication with the computing device and configured to generate the digital representation.

31. The system of claim 29, further comprising:
a data storage translator configured to receive the digital representation in the preferred file format and to apply the digital representation to a data storage medium responsive to the request to receive.

32. The system of claim 29, wherein the data manager comprises software configured to translate the digital representation from the first file format to the preferred file format.

33. The system of claim 29, further comprising:
a peripheral device communicatively coupled to the computing device configured to receive the digital representation and generate a hard-copy rendition of the image.

34. The system of claim 29, further comprising:
an image editor communicatively coupled to the computing device.
